(19) United States
(12) Patent Application Publication
(10) Pub. No.: US 2024/0220896 A1
(43) Pub. Date: Jul. 4, 2024

(54) A METHOD FOR CONTROLLING A PLURALITY OF VEHICLES

(71) Applicant: Volvo Autonomous Solutions AB, Göteborg (SE)

(72) Inventors: Jonas HELLGREN, Göteborg (SE); Mohammad Manjurul ISLAM, Göteborg (SE)

(73) Assignee: Volvo Autonomous Solutions AB, Göteborg (SE)

(21) Appl. No.: 18/551,923

(22) PCT Filed: Mar. 22, 2021
(86) PCT No.: PCT/EP2021/057291

§ 371 Date: Sep. 22, 2023

(51) Int. Cl. G06Q 10/0631; G06Q 30/0208

(52) U.S. Cl. CPC G06Q 10/06316; G06Q 30/0208

(57) ABSTRACT

A method for controlling a plurality of vehicles performing missions along a respective route includes obtaining for each vehicle of the plurality of vehicles, a first value of a balance parameter, indicative of a balance between a cost for operating the respective vehicle along at least a part of the route, and a progress of the respective vehicle along at least a part of the route, establishing, in dependence on the first balance parameter values, a desired number of completed missions as a function of time, after an initial of the missions has started, and before all missions are completed, determining a mission completion deviation comprising a deviation of an actual number of completed missions from the desired number of completed missions, obtaining for each of one or more of the vehicles a second balance parameter value, different from the respective first balance parameter value, the respective second balance parameter value being dependent on the mission completion deviation, and controlling the one or more of the vehicles in dependence on the respective second balance parameter value.

### TECHNICAL FIELD

The invention relates to a method for controlling a plurality of vehicles performing missions. The invention also relates to a computer program, a computer readable medium, and a control unit, or a group of control units.

The invention can be applied to heavy-duty vehicles, such as trucks and buses. Although the invention will be described with respect to trucks, the invention is not restricted to this particular type of vehicle, but may also be used in other vehicle types such as delivery vans and cars.

### BACKGROUND

Increasing the productivity, while keeping operating costs as low as possible, is an aim of many vehicle operations, in particular commercial vehicle operations.

US2019197475 describes utilizing a fleet of vehicles to deliver goods to various locations. A team of managers creates schedules for the deliveries. The document suggests managing a real-time request to modify a schedule by generating a set of modified schedules that consider different routes that can be used to implement the modification. A ranking technique is used to rank the set of modified schedules based on each modified schedule's impact on customer delivery windows, and operational costs to perform deliveries. The document suggests determining an overall score by determining a projected delivery time score for a modified schedule, by determining an operational cost score for the modified schedule, and by taking an average or a weighted average of the projected delivery time score and the operational cost score. It is suggested that by scoring and ranking the set of modified schedules, modified schedules can be identified that are beneficial both to a client organization and to end users.

However, there is a desire to further improve the control of a plurality of vehicles performing missions along a respective route to allow an increase of the productivity, while keeping operating costs as low as possible.

### SUMMARY

It is an object of the invention to increase the productivity of a plurality of vehicles performing missions along a respective route, while keeping operating costs as low as possible.

The object is reached with a method according to claim 1. Thus, the object is reached with a method for controlling a plurality of vehicles performing missions along a respective route, the method comprising
obtaining for each vehicle of the plurality of vehicles, a first value of a balance parameter, indicative of a balance between a cost for operating the respective vehicle along at least a part of the route, and a progress of the respective vehicle along at least a part of the route,
establishing, in dependence on the first balance parameter values, a desired number of completed missions as a function of time,
after an initial of the missions has started, and before all missions are completed, determining a mission completion deviation comprising a deviation of an actual number of completed missions from the desired number of completed missions,
obtaining for each of one or more of the vehicles a second balance parameter value, different from the respective first balance parameter value, the respective second balance parameter value being dependent on the mission completion deviation, and
controlling the one or more of the vehicles in dependence on the respective second balance parameter value.

The progress of the respective vehicle could be provided by a time of arrival at a position along the respective route. Thus, the respective first balance parameter value may be indicative of a balance between the respective operating cost, and a time of arrival at a position along the route. The operating cost could be a cost for operating the respective vehicle along the respective route, along a portion of the route, along a remainder of the route, or along a portion of the remainder of the route. The time of arrival at a position along the respective route, could be the time of arrival at the end of the route, or the time of arrival at a position before the end of the route.

The method may comprise controlling the vehicles in dependence on the respective first balance parameter value. Obtaining the respective first balance parameter value may be provided by determining the first balance parameter value. This determination may be done by a control unit located remotely from the vehicles. Such a control unit may determine the first balance parameter values for all vehicles. The determined first balance parameter values may be sent to the vehicles, e.g. wirelessly. However, in some embodiments, the respective first balance parameter may be determined onboard the respective vehicle. The first balance parameter values may be the same for all vehicles. Alternatively, the first balance parameter values may be individual values for the respective vehicles. The first balance parameter value may be obtained before the vehicle starts travelling along the route. Alternatively, the first balance parameter value may be obtained while the vehicle travels along the route.

The desired number of completed missions as a function of time may be determined based on data on the respective route, the vehicle models, and the first balance parameter values. The mission completion deviation determination may involve establishing a time correlated progress of the number of completed missions. The deviation of the actual number of completed missions from the desired number of completed missions, may be a deviation, for a point in time, of an actual number of completed missions at said point in time, from the desired number of completed missions at said point in time.

The second balance parameter values may be obtained when one or more of the vehicles travels along the respective route. The second balance parameter values may be obtained for all vehicles, e.g. if none of the vehicles have completed their respective missions. The second balance parameter values may be obtained for some of, or all of, the vehicles that have not yet completed their respective missions.

The respective second balance parameter values may be indicative of a balance between a cost for operating the respective vehicle along at least a part of the respective route, and a progress of the vehicle along at least a part of the route. The progress may be provided by a time of arrival at a position along the route. As suggested, the operating cost could be a cost for operating the respective vehicle along the respective route, along a portion of the route, along a remainder of the route, or along a portion of the remainder of the route. The time of arrival at a position along the respective route, could be the time of arrival at the end of the route, or the time of arrival at a position before the end of the route.

Obtaining the respective second balance parameter value may be provided by determining the second balance parameter value. This determination may be done by a control unit located remotely from the vehicles. Such a control unit may determine the second balance parameter values for all vehicles that have not yet completed their respective missions. The determined second balance parameter values may be sent to the vehicles, e.g. wirelessly. The first balance parameter values may be the same for all vehicles that have not yet completed their respective missions. Alternatively, the first balance parameter values may be individual values for the respective vehicles that have not yet completed their respective missions.

Thus, embodiments of the invention provide for changing one or more of the balance parameter values in dependence on the deviation of the actual number of completed missions from the desired number of completed missions. Compared to the first balance parameter values, the second balance parameter values may be indicative of a different balance between the cost for operating the respective vehicle along the respective route, and the respective progress. The second balance parameter values provide a way to reduce the deviation of the actual number of completed missions from the desired number of completed missions. The second balance parameter values may further provide for this deviation reduction while keeping the vehicle operating costs as low as possible during the remainder of the remaining missions.

Thus, the invention may provide dynamically changed balance parameter values. As a result of the first balance parameter values followed by the second balance parameter values, an adjustment can be made in view of an unexpected event along the route, e.g. a traffic jam, e.g. caused by an accident. For example, if an unexpected event delays one or more of the vehicles, so as to delay their respective mission completions, if the operating cost considerations are kept unchanged, the change of the balance parameter values, from the first balance parameter values to the second balance parameter values, could allow a more aggressive driving of at least some of the vehicles, in order to reduce their respective mission completions. In addition, each second balance parameter value may be such that, given the desire to reduce the delays of the respective mission completion, the vehicle operating cost for the remainder of the route, or a part thereof, is kept as low as possible.

Thus, the invention provides a reduction of the mission completion deviation, while keeping the costs for operating the vehicles along the route as low as possible. Reducing the mission completion deviation may provide an increase in the productivity of the vehicles. The invention allows avoiding or reducing a decrease of the productivity of the vehicles, due to one or more unexpected events along the route, while keeping operating costs as low as possible. This may be particularly advantageous in commercial vehicle operations.

The invention can be applied to any type of vehicles, e.g. a heavy-duty vehicles, such as trucks or buses, or another type of vehicle, such as a delivery vans or a cars. The invention is applicable to vehicles with any suitable type of drivetrain. For example, the drivetrains may include internal combustion engines as the sole propulsive devices, the drivetrains may be hybrid drivetrains, or the drivetrains may include electric motors as the sole propulsive device.

The vehicles may be autonomous vehicles. In some embodiments, the vehicles may be driven by human drivers. In the latter case instructions for the control of the vehicles may be communicated to the drivers, e.g. by means of visual displays, and/or with audio instructions.

As exemplified below, in addition to the mission completion deviation, the respective second balance parameter value may be dependent on the point in time for the determination of the mission completion deviation. As exemplified below, the second balance parameter value determination may be repeated during the executions of the missions. The influence of the point in time for the determination of the mission completion deviation may be exemplified as follows: A first point in time, that is further away from a point in time for the completion of all missions than a second point in time, may provide a second balance parameter value which, compared to a second balance parameter value provided for the second point in time, gives less prominence to the progress of the respective vehicle.

In some embodiments, the respective routes are identical to each other. Thereby, the missions performed by the vehicles may be identical. Thereby the routes of the missions may be identical. The missions may be transport missions e.g. in a quarry, or along a bus route. Thereby, where the routes are fixed, the dynamically changed balance parameter values that may be provided by the invention provide a particularly advantageous manner of avoiding or reducing a decrease of the productivity of the vehicles, while keeping operating costs as low as possible.

Preferably, the respective first value of the balance parameter is determined in dependence on the cost for operating the respective vehicle along at least a part of the respective route, wherein said cost is dependent on one or more of fuel consumption, electrical energy consumption, battery degradation, fuel cell degradation, and another degradation of the respective vehicle. Thereby, the cost is based on features of the technical operation of the respective vehicle. Thereby, an increased accuracy of the control of the vehicles may be accomplished.

Preferably, the method comprises establishing, in dependence on the respective first balance parameter value, for each of the vehicles a correlation set comprising a plurality of desired position and time correlations for the travel of the respective vehicle along at least a part of the respective route. The method may further comprise determining for each of the one or more of the vehicles a progress deviation indicative of a deviation of an actual progress of the respective vehicle along the respective route from a desired progress of the respective vehicle. Thereby, the respective progress deviation may comprise a deviation of an actual position of the respective vehicle from a desired position according to the respective correlation set. Further, the step of obtaining for each of the one or more of the vehicles a second balance parameter value may comprise determining the respective second balance parameter value in dependence on the respective progress deviation. The deviation of the actual position of the vehicle from the desired position according to the respective correlation set, may be for a point in time of the mission completion deviation.

Thereby, the respective second balance parameter value may be dependent on the individual progress of the respective vehicle. This is advantageous since the progress deviation, e.g. at a certain position along identical routes, may differ from one vehicle to another. Thereby, the second balance parameter values may differ from one vehicle to another. Thus, in addition to the mission completion deviation, the respective second balance parameter value may be dependent on a respective individual progress deviation. Thereby, an increased accuracy of the control of the vehicles may be accomplished.

However, in some embodiments, the second balance parameter values are determined independently of the respective progress deviations. Thereby, the second balance parameter values may be determined in dependence merely on the mission completion deviations.

In some embodiments, the respective second balance parameter value is determined in dependence on the mission completion deviation, and the point in time for the determination of the mission completion deviation. In some embodiments, the respective second balance parameter value is determined in dependence on the mission completion deviation, the respective progress deviation, and the point in time for the determinations of the mission completion deviation and the respective progress deviation.

In some embodiments, the method comprises pre-determining a plurality of balance parameter values, each for a respective pair of an assumed progress deviation and an assumed mission completion deviation. Thereby, the step of obtaining for each of the one or more of the vehicles a second balance parameter value comprises selecting the respective second balance parameter value from the pre-determined balance parameter values in dependence on the progress deviation of the respective vehicle, and the mission completion deviation determined after the initial of the missions had started. Thereby, the computational requirements for establishing the balance parameter value may be reduced.

In some embodiments, the method comprises pre-determining a plurality of balance parameter values, each for a respective assumed mission completion deviation, wherein the step of obtaining for each of the one or more of the vehicles a second balance parameter value comprises selecting the respective second balance parameter value from the pre-determined balance parameter values in dependence on the mission completion deviation determined after the initial of the missions had started. Thereby, an embodiment of the method which is simple to implement may be provided. For example, as suggested, in some embodiments, no individual progress deviation for the vehicles is determined. Thereby, the second balance parameter value may be determined based on the mission completion deviation, and the pre-determined balance parameter values.

In some embodiments, the method comprises determining, in dependence on the respective second balance parameter value, a respective velocity profile for a respective of the one or more of the vehicles for at least a portion of the respective remainder of the respective route, and controlling the respective of the one or more of the vehicles according to the respective determined velocity profile.

Thereby, an optimal vehicle speed at positions along the remainder of the route, or a portion thereof, may be provided by the respective velocity profile, in dependence on respective the second balance parameter value. Thereby, an optimal tradeoff between the vehicle operating cost and the progress, may be provided.

The respective velocity profile may be propagated to one or more vehicle control functions. The vehicle control functions may use the respective velocity profile as a speed reference. The respective velocity profile may be calculated by means of a cost function.

The respective second balance parameter value may be a weight factor in the cost function. The respective velocity profile may be determined by means of a computer, e.g. in a control unit for controlling the vehicles, comprising processing means and a memory. The respective velocity profile may be computed using dynamic programming. However, other computational techniques may be used for the respective velocity profile.

The method may comprise obtaining a respective vehicle model in the form of a mathematical model for the respective of the one or more of the vehicles, wherein the respective velocity profile is determined by means of the respective vehicle model. Thereby, accurate speed profiles may be provided. The establishment of the respective correlation set may be done by means of the vehicle model.

The method may comprise obtaining data for the respective route, wherein the respective velocity profile is determined in dependence on the route data. The route data may comprise inclination data, curvature data, and/or speed limit data. Thereby, accurate speed profiles may be provided. The establishment of the respective correlation set may be done by means of the route data. In particular, the establishment of the respective correlation set may be done by means of the respective route data, the respective vehicle model, and the respective balance parameter value.

The respective velocity profile may be a second velocity profile. In dependence on the respective first balance parameter value, a first velocity profile for the respective vehicle may be determined for at least a part of the route. Thereby, the respective vehicle may be controlled according to the first velocity profile, wherein the second velocity profile replaces the first velocity profile for the control of the vehicle. The first velocity profile may be determined for the respective route, a portion of the route, a remainder of the route, or a portion of the remainder of the route. The respective first velocity profile may be established when travelling along the route or before travelling along the route. The respective second velocity profile may be different from the respective first velocity profile. The velocity profile replacement may secure a reduction of a respective arrival time deviation, e.g. in view of an unexpected event.

Preferably, the method comprises establishing, in dependence on the second balance parameter values, a desired number of completed missions as a function of time. Thereby, a further mission completion deviation may be determined in dependence on the desired number of completed missions, established in dependence on the second balance parameter values. Thereby, the second balance parameter value determinations may be repeated.

Preferably, the method comprises determining a plurality of sets of balance parameter values, each set being provided for a respective mission completion deviation, and each set including balance parameter values for one, more, or all of the vehicles. In such a set, the balance parameter values may be dissimilar or the same. A set could include a single balance parameter value for one, more, or all of the vehicles. The mission completion deviations may be predetermined. The mission completion deviations and the balance parameter values may be stored before the vehicles start travelling on the respective routes. The mission completion deviations and the balance parameter values may be stored in a control unit remotely from the vehicles. Thereby, a bank of predetermined balance parameter value sets, for respective mission completion deviations, may be provided. Upon an actual mission completion deviation being established, the mission completion deviation may be mapped to a predetermined set of balance parameter values. This may reduce the computational requirements for establishing the balance parameter values, once the actual mission completion deviation has been established. The predetermined balance parameter values may be stepped. This will reduce the data amount in the method.

Alternatively, a set of balance parameter values may be calculated upon an establishment of an actual mission completion deviation.

The method may comprise repeating a plurality of times, as the vehicle travels along the route, determining a mission completion deviation, obtaining for each of one or more of the vehicles a second balance parameter value, and controlling the vehicles in dependence on the second balance parameter values. Obtaining the balance parameter values may be repeated within predetermined time intervals. The method may comprise repeating a plurality of times a determination, in dependence on the second balance parameter values, of respective velocity profiles for the vehicles for at least a portion of the remainder of the route, wherein the second balance parameter values, obtained in a repeated step of obtaining second balance parameter values, replaces, for the velocity profile determinations, the second balance parameter values obtained in a previous step of obtaining second balance parameter values. Determining the velocity profile may be repeated within predetermined time intervals.

Thereby, velocity profiles may be determined, in dependence on the most recently obtained second balance parameter values, and the vehicles may be controlled according to the determined velocity profiles. Thus, a series of balance parameter values, or sets of balance parameter values, may be obtained, as the vehicles travel along the respective route. In embodiments of the invention, what is herein referred to as first balance parameter values, may be followed by a series of second balance parameter values, or sets of second balance parameter values. The balance parameter values may also be referred to as first, second, third, fourth balance parameter values, etc. Thus, as the vehicles travel along the respective route, the velocity profiles may be repetitively updated in dependence on updated mission completion deviations.

In some embodiments, the velocity profile determinations are repeated more often than the step of obtaining second balance parameter values. For example, the velocity profiles may be repetitively updated within intervals of 5 seconds-5 minutes. As a further example, the balance parameter values may be repetitively updated within intervals of 1-60 minutes.

Preferably, the method comprises repeating establishing, in dependence on the second balance parameter values, a desired number of completed missions as a function of time. Thereby, a series of desired number of completed missions as a function of time may be established. Thereby, each of the repeated mission completion deviation determinations may be dependent on a respective of the pluralities of desired number of completed missions as a function of time. Thereby, each of further second balance parameter values, or further sets of second balance parameter values, may be dependent on a respective mission completion deviation, in turn dependent on a respective of the pluralities of desired number of completed missions.

The missions that the vehicles perform may form a present set of missions. The method may comprise performing a previous set of missions, wherein the respective second balance parameter value is determined in dependence on the previous set of missions. Thereby, the method may comprise determining, for the previous set of missions, a value of a reward parameter, in dependence of a deviation of an actual time to complete all missions in the previous set of missions, from a desired time to complete all missions in the previous set of missions, wherein the respective second balance parameter value is determined in dependence on the reward parameter value. The respective second balance parameter value may also be determined in dependence on a cost for operating the vehicles at the previous set of missions.

Thereby, any delays, as well as operating costs, of the previous set of missions may be used as a base for the second balance parameter value determination. Thereby, a beneficial manner of determining the respective second balance parameter value is provided.

The missions in the previous set of missions may be performed along the respective route, or along a respective virtual reality route in the form of a virtual reality representation of the respective route. The previous set of missions may be performed before the vehicles start the present set of missions.

The previous set of missions may be performed once. Preferably, the previous set of missions is performed a plurality of times. For example, at least some of the previous set of missions may be simulated. Thus, the method may comprise providing a respective virtual reality route in the form of a virtual reality representation of the respective route, and simulating, a plurality of times, the travel of the respective vehicle along the virtual reality route, wherein the second balance parameter values are determined in dependence on the simulations. The vehicles of the simulations may be representations of vehicles which are the same as, or similar to, the vehicles performing the present set of missions, e.g. having the same, or a similar, type of drivetrain, and/or substantially the same load.

At least some of the previous set of missions may be real missions of vehicles along the route. Thereby, at least some of the previous set of missions may be productive set of missions, e.g. by involving the transport of goods and/or people. Preferably, the vehicles performing the real previous set of missions are of the same type as the vehicles performing the present set of missions, or the same as the vehicles performing the present set of missions. Preferably, the vehicles performing the real previous set of missions have substantially the same load as one or more of the vehicles performing the present set of missions.

A previous set of missions may involve obtaining first balance parameter values, determining a mission completion deviation, obtaining second balance parameter values dependent on the mission completion deviation, and controlling the vehicles in dependence on the second balance parameter values.

The respective second balance parameter values may be determined in dependence on an outcome of a machine learning process at the previous set of missions. The machine learning process may be dependent on the reward parameter values determined for respective earlier previous set of missions. Thereby, a control unit determining the balance parameter values may be “pre-trained” by the machine learning process. Where a previous set of missions are simulated, the simulations may expose the control unit to a plurality of different driving situations. The simulations may include virtual objects along the virtual route. The machine learning at the simulations may be similar to that of autonomous vehicle perception training.

The reward parameter may be defined in any suitable way. The reward parameter value may indicate how well the vehicles have performed in terms of mission completion time and operating cost. The reward parameter may present high values for “good” results, and low values for “bad” results. Of course, the reward parameter may also be provided in the form of a penalty parameter, presenting high values for “bad” results, and low values for “good” results. A reward can be indicated as a negative value of the penalty parameter value, and vice versa.

The reward parameter may have two parts, one related to the mission completion time, and another related to the operation cost. The mission completion time part may make a contribution to the reward parameter value, which is higher at a relatively small mission completion time deviation, than at a relatively large mission completion time deviation. The mission completion time deviation part may provide a time corridor around the mission completion time, within which corridor the contribution to the reward parameter value is relatively high, and outside of which corridor, the parameter value is relatively low. Thereby, a stepwise penalty may be provided.

Preferably, a large amount of previous sets of missions are performed, e.g. by simulations. For example, at least 100, or at least 1000, previous sets of missions may be performed, wherein a reward parameter value is determined for each set of missions. Thereby, through machine learning, a control unit may correlate “good” reward parameter values to certain balance parameter values in certain driving situations. Thereby, the control unit may learn to provide a well-selected balance parameter value, even if the reward parameter does not give a grade for individual actions of the vehicles within the previous sets of missions.

Preferably, the respective second balance parameter value is determined by a control unit located remotely from the vehicles. The control unit may be included in, or provided in the form of, a vehicle fleet management system. Thereby, a coordinated control of the vehicles may be provided.

The object is also reached with a computer program according to claim 17, a computer readable medium according to claim 18, or a control unit, or a group of control units, according to claim 19.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic view of a vehicle and a stationary control unit.

FIG. 2 is a diagram depicting the control unit in FIG. 1 and a plurality of vehicles as the one in FIG. 1.

FIG. 3 is a diagram depicting vehicle missions as functions of time.

FIG. 4 is a diagram depicting steps in a method, according to an embodiment of the invention, for controlling the vehicles performing the missions depicted in FIG. 3.

FIG. 5a is a diagram of the progress of one of the vehicles performing the missions depicted in FIG. 3, as a function of time.

FIG. 5b is a diagram of mission completions as functions of time.

FIG. 6 is a flow diagram depicting steps in a machine learning process for the method depicted in FIG. 4.

FIG. 7 is a flow diagram depicting steps in a method according to a more general embodiment of the invention.

### DETAILED DESCRIPTION OF EXAMPLE EMBODIMENTS OF THE INVENTION

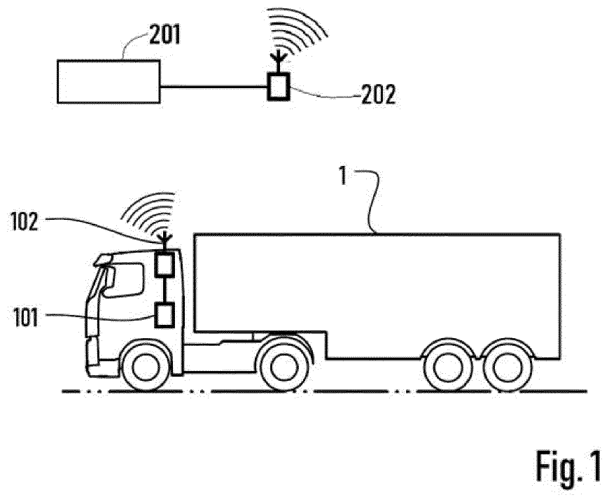

FIG. 1 shows a vehicle 1. In this example, the vehicle 1 is a truck with a semitrailer. However, the invention is equally applicable to other types of vehicles, such as cars, buses, dump trucks, and mining vehicles.

The vehicle includes a powertrain. The powertrain includes a propulsion arrangement. Embodiments of the invention are applicable to a variety of propulsion arrangements. The propulsion arrangement may include an internal combustion engine. The vehicle may be arranged to be driven by an engine only. The propulsion arrangement may include an electric motor. The propulsion arrangement may be a hybrid arrangement with an engine and a motor.

The vehicle comprises a vehicle control unit 101, arrange to control functions of the vehicle, such as its propulsion, and braking. The control unit is arranged to control the propulsion arrangement. The vehicle control unit is arranged to control a braking system of the vehicle. The vehicle control unit 101 may be provided as a single physical unit, or as a plurality of physical units, arranged to communicate with each other.

The vehicle also comprises vehicle equipment for wireless communication 102. The vehicle control unit 101 is arranged to receive data via the vehicle communication equipment 102.

FIG. 1 also shows a stationary control unit 201. The stationary control unit 201 may be located remotely from the vehicle. The stationary control unit 201 may be provided as a computer. The stationary control unit 201 is connected to stationary equipment for wireless communication 202. The stationary control unit 201 is arranged to send data via the stationary communication equipment 202.

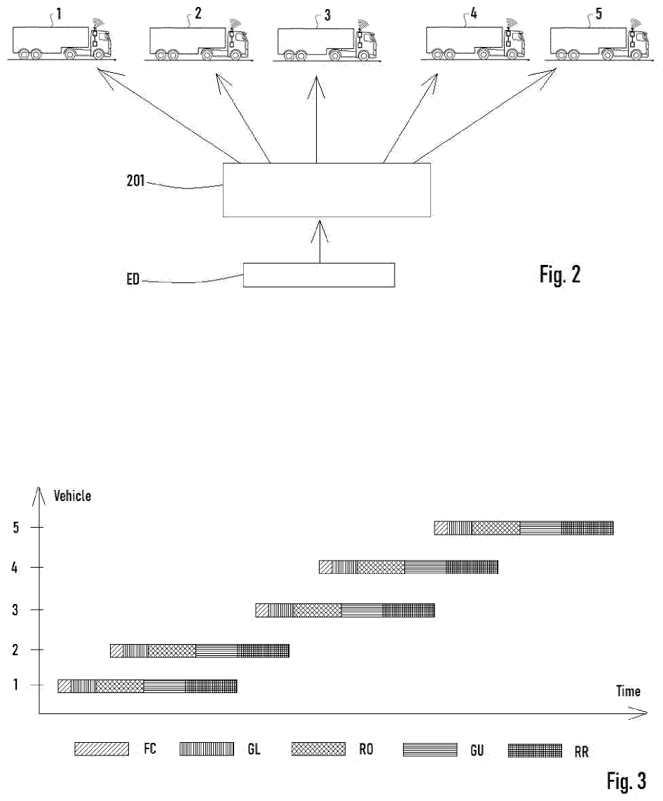

Reference is made also to FIG. 2. The stationary control unit 201 is provided in the form of a fleet management system arranged to control a plurality of vehicles 1-5, such as the one described with reference to FIG. 1. An operator or a transport buyer may provide an order to the control unit 201. The order may stipulate that certain goods items shall be transported from a certain location to another location in a specific time window. The control unit 201 is arranged to transform the order to a stream of commands to the vehicles 1-5.

Said transformation comprises converting the order to a set of missions. Each mission is for a respective of the vehicles. The control unit 201 is arranged to receive environment data ED, which may include route data, traffic data, and weather data. The control unit 301 is arranged to plan the missions based on the order and the environment data ED.

Reference is made also to FIG. 3. The control unit is arranged to determine the set of missions in a scheduled form. FIG. 3 illustrate a simple example of scheduled missions. Each mission comprises a fueling or charging step FC, in which the respective vehicle is fueled or charged. The fueling or charging step FC is followed by a goods loading step GL. The goods loading step GL is followed by an outward route travel step RO. The outward route travel step RO is followed by a goods unloading step GU. The goods unloading step is followed by a return route travel step RR.

Thus, each mission may follow a route. The route may include an outward route portion. The route may further include return route portion. The route may be the same for all missions. Alternatively, any of the routes may differ from one or more of the other routes. For example, a route may be changed during a mission while the locations for the goods loading step GL, and the goods unloading step GU may remain unchanged.

As can be seen in FIG. 3, the missions are mutually offset in time. The vehicles may perform a respective of the missions. Alternatively, one or more of the vehicles may each perform two or more of the missions.

The control unit 201 supervises the progress of the missions, and determines adjustments of the executions of the missions, as exemplified below. The control unit 201 tracks the mission schedule. The control unit 201 issues, repetitively or continuously, commands to the vehicles 1-5. The commands may include information on respective next waypoints for the vehicles, and/or instructions on fueling or charging.

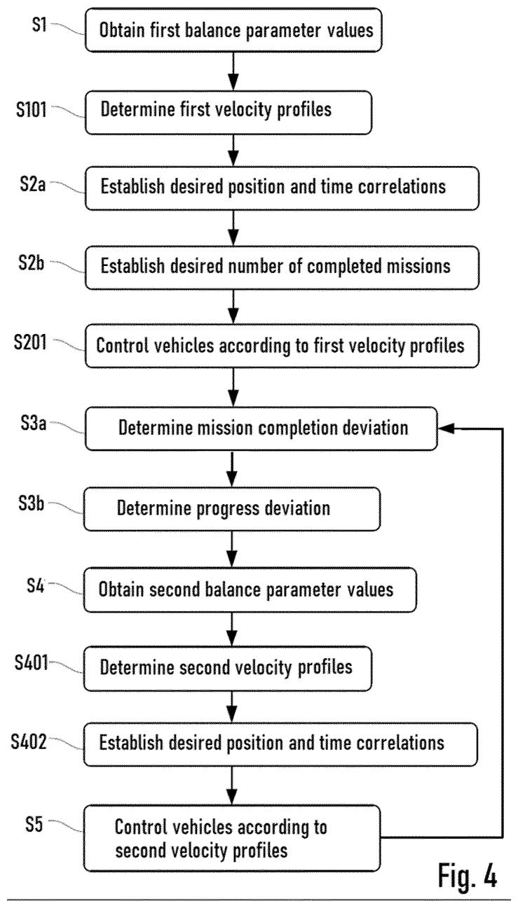

With reference to FIG. 4, a method according to an embodiment of the invention will be described. The method is provided for controlling the plurality of vehicles performing missions along a respective route. The route can be of any length, e.g. 5, 50, or 500 km. For commercial vehicles, a trip along the respective route can be for transporting goods and/or persons, from one location to another location.

The method comprises obtaining S1 obtaining for each vehicle of the plurality of vehicles, a first value of a balance parameter. The first balance parameter value may be the same for all vehicles. Alternatively, the first balance parameter value of a vehicle may be different from one vehicle to another. Each balance parameter value is indicative of a balance between a cost for operating the respective vehicle along at least a part of the route, and a time of arrival at a position along the route.

The balance parameter may be a normalized weight factor α. The balance between the operating cost and the arrival time may be illustrated by the following equation:

$${R}_{i} = {α}_{i} \cdot {R}_{rev , i} - {c}_{oper , , i} \qquad ( 1 )$$

where Ri is a reward for a vehicle with index i, αi is a balance parameter for the vehicle i, Rrev,i is a progress parameter which is proportional to the distance travelled by the vehicle i, and coper,i is the operating cost of the vehicle i. If the balance parameter αi has a large value, commands resulting in more motion will be favored. Therefore, it is possible to influence the rate of goods movements by setting the balance parameter αi. Preferably, the balance parameter for each vehicle i is set so as to maximize the sum of the rewards Ri for the vehicles.

The respective first balance parameter value is herein denoted αi1. In dependence on the respective first balance parameter value αi1, a first velocity profile for the respective vehicle for the route is determined S101. As the respective vehicle starts travelling along the route, the vehicle is controlled S201 according to the respective first velocity profile.

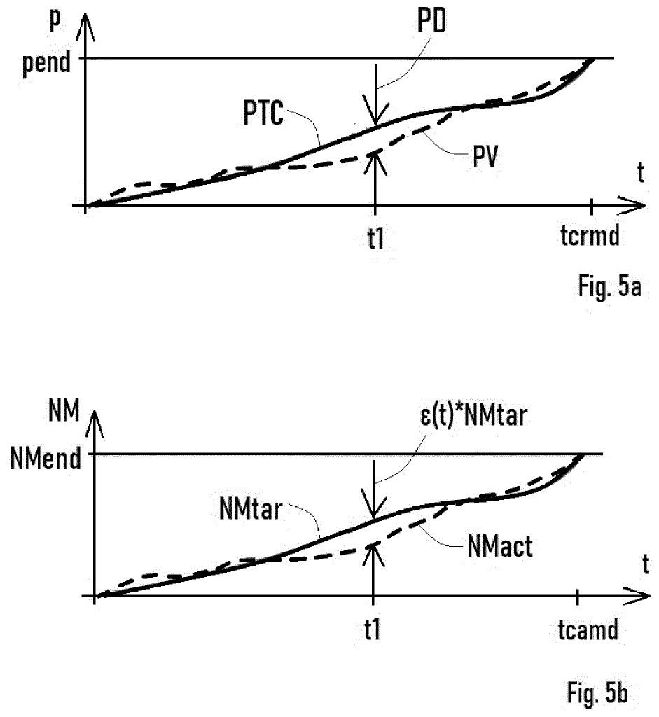

Reference is also made to FIG. 5a. The method further comprises establishing S2a, in dependence on the respective first balance parameter value, a plurality of desired position and time correlations PTC for the travel of the respective vehicle along the route. The desired position and time correlations PTC may be provided based on the respective first velocity profile. The first velocity profile may be determined while the respective vehicle is stationary, e.g. before the travel along the route starts.

The respective first velocity profile provides a velocity as a function of positions along the route. The velocity at a position may depend on a maximum speed, the road inclination, and the first balance parameter value αi1.

There may be an allowed time of arrival of the respective vehicle, at the end of the route. The allowed time of arrival may be between a minimum time and a maximum time. It may be assumed that a relatively low velocity will, compared to a relatively high velocity, reduce the operating cost. Of course, the lower the velocity is, the longer time it takes to reach the end of the route. The first balance parameter value αi1 may be set so as for the first velocity profile resulting in the vehicle reaching the end of the route pend at the latest allowed point in time.

The method further comprises establishing S2b, in dependence on the first balance parameter value, a desired number of completed missions.

As the respective vehicle starts travelling along the route, the vehicle is controlled S201 according to the respective first velocity profile.

Reference is made also to FIG. 5b. When the execution of the set of missions has started, a mission completion deviation ε(t) is determined S3a. The mission completion deviation ε(t) comprises a deviation, for a point in time, of an actual number of completed missions NMact at said point in time, from the desired number of completed missions NMtar at said point in time. The mission completion deviation ε(t) may be defined as follows:

$$ε ( t ) = ( N {M}_{tar} ( t ) - N {M}_{α c t} ( t ) ) / {NM}_{tar} \qquad ( 2 )$$

Thereby, a positive mission completion deviation ε(t) means that the number of completed missions is below its target.

In the example in FIG. 5b, the mission completion deviation ε(t) is determined at a point in time t1. In the example in FIG. 5b, the mission completion deviation ε(t1) at t1 is such that the actual number of completed missions NMact is lower than the desired number of completed missions NMtar.

Reference is made again to FIG. 5a. When the respective vehicle travels along the route, an individual progress deviation PD is determined S3b. The progress deviation PD comprises a deviation, for a point in time, of an actual position of the vehicle from a desired position according to the desired position and time correlations PTC. Of course, alternatively, the progress deviation PD may comprise a deviation, for a position of the vehicle, of an actual point in time from a desired point in time according to the desired position and time correlations. In the example in FIG. 5a, the progress deviation PD is determined at said point in time t1. Thereby, the progress deviation PD is such that the actual position PV of the vehicle is behind the desired position PTC.

Thus, in this example, the mission completion deviation ε(t) and the progress deviation PD are determined at for the same point in time t1. Alternatively, these deviations may be determined at different points in time.

It should be noted that the time span for the execution of all missions may be longer than the time span for the execution of a single mission, e.g. due to the missions being offset as depicted in FIG. 3. Therefore, the time interval shown in FIG. 5a may be shorter than the time interval shown in FIG. 5b.

In this example, the progress deviation PD is normalized against the length of the route. A positive progress deviation may be defined as a progress deviation in which the actual progress PV of the vehicle is less than the desired progress PTC.

Upon determining the mission completion deviation ε(t) and the progress deviations PD, for each of the vehicles which have not yet completed their respective missions, a second balance parameter value αi2, different from the respective first balance parameter value αi1, is obtained S4. The respective second balance parameter value is dependent on the mission completion deviation ε(t), and the respective progress deviation PD.

The respective second balance parameter value is also dependent on the point in time t1 for the determination of the mission completion deviation ε(t) and the respective progress deviations PD. Thereby, the time may be normalized. Thereby, the second balance parameter value may be dependent on the time t1 for the determination of the mission completion deviation ε(t), in relation a desired time for completing all missions tcamd, exemplified in FIG. 5b. For example, the second balance parameter value may be dependent on the time t1 for the determination of the mission completion deviation divided by the desired time for completing all missions tcamd.

In addition, the second balance parameter value may be dependent on the time t1 for the determination of the respective progress deviation PD, in relation a desired time for completing the respective mission tcrmd, exemplified in FIG. 5a. For example, the second balance parameter value may be dependent on the time t1 for the determination of the respective progress deviation PD divided by the desired time for completing the respective mission tcrmd.

Given that all other second balance parameter value input parameters are the same, a relatively high value of the normalized time may justify a balance parameter value that gives more support to the vehicle progress and less consideration for the operation cost, compared to a balance parameter value provided in dependence on a relatively low value of the normalized time.

In this example, the second balance parameter value is determined by the stationary control unit 201. For the determination, the progress deviation PD may be sent from the respective vehicle to the stational control unit. When the second balance parameter value is determined, the stationary control unit sends it to the respective vehicle.

A second velocity profile is determined S401 for the respective vehicle. The determination of the second velocity profile involves a weighting function. The weighting function may be a function of the operating cost of the respective vehicle, the duration of the travel of the respective vehicle, and the second balance parameter value for the respective vehicle.

The balance of the operating cost and the duration may be adjusted by means of the second balance parameter value.

For example, the weighting function can be

$$C T = ( 1 - α i 2 ) * Coper + α i 2 * t \qquad ( 3 )$$

where CT is a total cost, Coper is the operating cost, t is the time for travelling, and αi2 is the second balance parameter value. In this example, the second balance parameter value αi2 is in the interval 0 to 1. The second velocity profile may be determined with an aim to minimize the total cost CT in the weighting function above.

In this example, the larger the mission completion deviation ε(t) is, the larger the respective second balance parameter value αi2 will be. Further, the larger the progress deviation PD of the respective vehicle is, the larger the respective second balance parameter value αi2 will be. A relatively large second balance parameter value αi2 will allow a relatively high operating cost, and it will require a relatively short time for the respective vehicle for travelling along the route, or the remainder of the route.

It should be noted that the method may comprise determining an anticipated traffic situation along the route, and determining the second balance parameter value in dependence on the anticipated traffic situation.

Thus, the second velocity profile is determined S401 in dependence on the second balance parameter value αi2. The second velocity profile is determined for the respective vehicle for a respective portion of the remainder of the route. Thereby, the second velocity profile replaces the first velocity profile for the control of the vehicle.

The second velocity profile may be determined by means of a mathematical model of the respective vehicle. The vehicle model may include a model of the powertrain. The model may include energy losses of the powertrain. The vehicle model may include a model of the propulsion arrangement. Where the propulsion arrangement includes an internal combustion engine, the model may include the engine, and allow the determination of the fuel consumption. Where the propulsion arrangement is an electric hybrid propulsion arrangement, or a fully electric propulsion arrangement, the vehicle model may include a model of the electric motor, and a model of an electric storage device, such as a battery, or a battery pack. The electric storage device model may include a model of the state of health of the storage device. The electric storage device model may include a battery degradation model. The storage device capability may be dependent on a state of charge of the storage device. In some embodiments, the vehicle model may include a model of a fuel cell. The vehicle model may further include a model of a braking system of the vehicle. The braking system may include service brakes. The braking system may include a function of regenerative braking by means of the motor and the storage device. Further, the vehicle model may include a model of a road friction. The method may aim to minimize the use of the service brakes.

For the velocity profile, data for the route portion, herein also referred to as route data, is obtained. Thereby, the velocity profile is determined in dependence on the route data. The route data comprises topology data, indicative of a topology of the route, or a portion thereof. The topology data may be obtained from map data. The velocity profile determination comprises establishing a sequence of velocity profile positions along the portion of the remainder of the route. The stretch of the route between two adjacent velocity profile positions is herein referred to as a segment. For example, the length of the segments may be 10 meters. In dependence on the topology data, an altitude is associated with each position.

The method further comprises establishing S402, in dependence on the second balance parameter value, a plurality of desired position and time correlations for the travel of the respective vehicle along the remainder of the route. The desired position and time correlations may be provided based on the second velocity profile.

The method in this embodiment further comprises controlling S5 the vehicles according to the determined respective second velocity profiles. Thereby, the vehicles are controlled in dependence on the respective second balance parameter values αi2. The second velocity profiles replace the first velocity profiles for the control of the vehicles.

In this embodiment, the method comprises repeating a plurality of times, as the vehicles travel along the route, determining a mission completion deviation, determining a respective progress deviation PD, and obtaining a respective second balance parameter value dependent on the mission completion deviation, the progress deviations, and the point in time for the determinations of the mission completion deviation and the progress deviations. Further the method comprises repeating a plurality of times, determining, in dependence on the further second balance parameter values, a respective velocity profile for the respective vehicle for at least a portion of the remainder of the route. In this embodiment, the velocity profile determinations are repeated more often than the step of obtaining second balance parameter values. The velocity profile determinations may be done at regular time intervals, or driving distance intervals, e.g. every 100 metres.

The method involves the use of predetermined balance parameter values. The vehicles perform, when travelling along the route, what is herein referred to as a present set of missions. In this embodiment, a bank of predetermined balance parameter values, each for a respective pair of an assumed mission completion deviation and an assumed progress deviation, is provided. This will reduce the computational requirements in the present set of missions for establishing a balance parameter value, once a mission completion deviation and a respective progress deviation have been established. Upon an actual mission completion deviation and an actual respective progress deviation being established, the pair of the actual mission completion deviation and the actual respective progress deviation may be mapped to a pair of an assumed mission completion deviation and an assumed progress deviation in said bank of predetermined balance parameter values. Based on the pair of the assumed mission completion deviation and the assumed progress deviation, a predetermined balance parameter value can be selected.

For providing this bank of predetermined balance parameter values, the method comprises determining a plurality of balance parameter values, each for a respective pair of an assumed mission completion deviation and an assumed progress deviation. The balance parameter values, as well as the pairs of assumed mission completion deviations and assumed progress deviations, may be stored, e.g. in the stationary control unit 201, before the vehicle start travelling on the route.

It should be noted that in alternative embodiments, in addition to a respective pair of an assumed mission completion deviation and an assumed progress deviation, each balance parameter value, in the bank of predetermined balance parameter values, may be provided for an assumed normalized point in time for the determinations of the assumed mission completion deviation and the assumed progress deviation.

It should be noted that in alternative embodiments, a bank of predetermined balance parameter values, each for an assumed mission completion deviation, is provided. Thereby, the actual respective progress deviation may be ignored when determining the balance parameter value. In addition to the assumed mission completion deviation, each balance parameter value may be provided for an assumed normalized point in time for the determination of the assumed mission completion deviation.

In this embodiment, for providing the bank of predetermined balance parameter values, the method comprises performing, a plurality of times, a previous set of missions along the route, or along a virtual reality route in the form of a virtual reality representation of the route. Thereby, in dependence on the previous set of missions, a plurality of balance parameter values are determined, for respective pairs of assumed mission completion deviations and assumed progress deviations. Thereby, the respective second balance parameter values αi2 in the present set of missions are determined in dependence on the previous set of missions.

Providing the balance parameter value bank comprises determining, for each previous set of missions, a value of a reward parameter, in dependence of a deviation of an actual time to complete all missions in the previous set of missions, from a desired time to complete all missions in the previous set of missions. Thereby, the balance parameter values are determined in dependence on an outcome of a machine learning process at the previous sets of missions. The machine learning process involves the use of the reward parameter values determined for respective earlier previous sets of missions.

As an example, in a previous set of missions, balance parameter values will be determined in response to mission completion deviations and respective progress deviations, similar to as described above in relation to the present trip. When all missions in the previous set of missions have been completed, a value of the reward parameter will be set for the previous set of missions. The “better” the outcome of the balance parameter value determinations are, the larger reward will be. The reward parameter value will be stored and correlated with the present trip.

As an example, the reward parameter may be defined as

$$ReW = - Coper + Ψ \qquad ( 4 )$$

where, Coper is the cost for operating the vehicles at the previous set of missions. As suggested above, the operating cost can include aspects such as fuel consumption, electricity consumption, and/or battery degradation. Ψ is a penalty function. It is zero if all missions are completed within a desired time. If one or more missions are completed too late, the penalty function Ψ has a negative value. With increasing delays, the penalty function Ψ has an increasing negative value.

The balance parameter value bank may be provided by the control unit 201, described above. The machine learning process may be provided by the control unit 201. Based on the machine learning process, the control unit 201 sets the balance parameter values in an optimal manner.

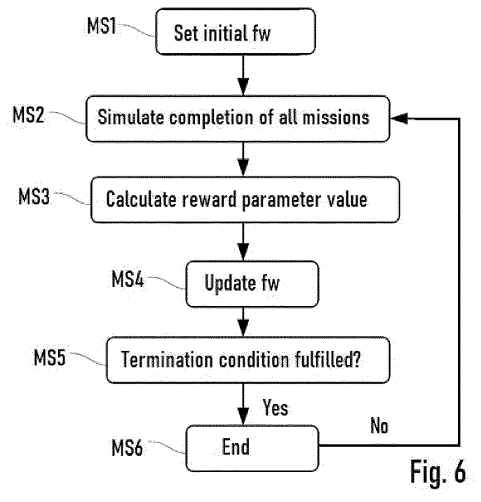

Reference is made also to FIG. 6 depicting steps in a machine learning process for optimizing a balance parameter value. The balance parameter value may be used by all vehicles performing a respective of a set of missions. For example, the balance parameter value may be used as the first balance parameter value in the method described with reference to FIG. 4.

The machine learning process may comprise repeating virtual sets of missions, to optimize the balance parameter values. Thereby, the mission sets may be simulated. The simulations may be done by a computer, e.g. of the control unit 201, comprising data processing means, and a memory. The bank of balance parameter values may be provided by a function fw that maps mission completion deviations, normalized times for the mission completion deviations, and optionally vehicle individual progress deviations, to balance parameter values.

An initial property is given MS1 to the function fw. An execution of all missions is simulated MS2. A reward parameter value is determined MS3 for the executed missions, e.g. as exemplified above by using equation (4). Based on the reward parameter value, the property of the function fw is updated MS4.

Based on the updated function fw, it is determined MS5 whether a termination condition for the mission set repetitions is fulfilled. The termination condition can for example be dependent on a value of a probability of the set of missions not being completed within the desired time. In addition, or alternatively, the termination condition can be dependent on the increase of an average value of the reward parameter values provided MS3 in the repeated the mission set executions. A condition for the termination MS5 may be that this average value is increasing below a reward parameter increase threshold value.

If it is determined MS5 that the termination condition is not fulfilled, a further execution of all missions is simulated MS2. If it is determined MS5 that the termination condition is fulfilled, the mission set execution repetition is ended MS6.

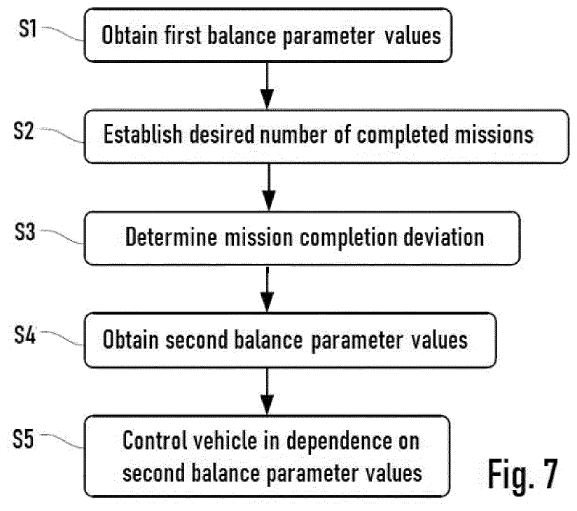

Reference is made to FIG. 7, showing a flow diagram of a method according to a more general embodiment of the invention, for controlling a plurality of vehicles performing missions along a respective route. The method comprises obtaining S1 obtaining for each vehicle of the plurality of vehicles, a first value of a balance parameter, indicative of a balance between a cost for operating the respective vehicle along at least a part of the route, and a progress of the vehicle along at least a part of the route. The method further comprises establishing S2, in dependence on the first balance parameter values, a desired number of completed missions as a function of time. The method further comprises, after an initial of the missions has started, and before all missions are completed, determining S3 a mission completion deviation comprising a deviation, for a point in time, of an actual number of completed missions at said point in time, from the desired number of completed missions at said point in time. The method further comprises obtaining S4 for each of one or more of the vehicles a second balance parameter value, different from the respective first balance parameter value, the respective second balance parameter value being dependent on the mission completion deviation. The method further comprises controlling S5 the vehicle in dependence on the second balance parameter value.

It is to be understood that the present invention is not limited to the embodiments described above and illustrated in the drawings; rather, the skilled person will recognize that many changes and modifications may be made within the scope of the appended claims.

1. A method for controlling a plurality of vehicles performing missions along a respective route, the method comprising,
obtaining for each vehicle of the plurality of vehicles, a first value of a balance parameter, indicative of a balance between a cost for operating the respective vehicle along at least a part of the route, and a progress of the respective vehicle along at least a part of the route, characterized by
establishing, in dependence on the first balance parameter values, a desired number of completed missions as a function of time,
after an initial of the missions has started, and before all missions are completed, determining a mission completion deviation comprising a deviation of an actual number of completed missions from the desired number of completed missions,
obtaining for each of one or more of the vehicles a second balance parameter value, different from the respective first balance parameter value, the respective second balance parameter value being dependent on the mission completion deviation, and
controlling the one or more of the vehicles in dependence on the respective second balance parameter value.

2. A method according to claim 1, characterized in that the respective routes are identical to each other.

3. A method according to claim 1, characterized in that the respective first value of the balance parameter is determined in dependence on the cost for operating the respective vehicle along at least a part of the respective route, wherein said cost is dependent on one or more of fuel consumption, electrical energy consumption, battery degradation, and another degradation of the respective vehicle.

4. A method according to claim 1, characterized by establishing, in dependence on the respective first balance parameter value, for each of the vehicles a correlation set comprising a plurality of desired position and time correlations for the travel of the respective vehicle along at least a part of the respective route.

5. A method according to claim 1, characterized by determining for each of the one or more of the vehicles a progress deviation indicative of a deviation of an actual progress of the respective vehicle along the respective route from a desired progress of the respective vehicle.

6. A method according to claim 5, characterized by establishing, in dependence on the respective first balance parameter value, for each of the vehicles, a correlation set comprising a plurality of desired position and time correlations for the travel of the respective vehicle along at least a part of the respective route, wherein the respective progress deviation comprises a deviation, for said point in time, of an actual position of the vehicle from a desired position according to the respective correlation set.

7. A method according to claim 5, characterized in that the step of obtaining for each of the one or more of the vehicles a second balance parameter value comprises determining the respective second balance parameter value in dependence on the respective progress deviation.

8. A method according to claim 5, characterized by pre-determining a plurality of balance parameter values, each for a respective pair of an assumed progress deviation and an assumed mission completion deviation, wherein the step of obtaining for each of the one or more of the vehicles a second balance parameter value comprises selecting the respective second balance parameter value from the pre-determined balance parameter values in dependence on the progress deviation of the respective vehicle, and the mission completion deviation, determined after the initial of the missions had started.

9. A method according to claim 1, characterized by pre-determining a plurality of balance parameter values, each for a respective assumed mission completion deviation, wherein the step of obtaining for each of the one or more of the vehicles a second balance parameter value comprises selecting the respective second balance parameter value from the pre-determined balance parameter values in dependence on the mission completion deviation determined after the initial of the missions had started.

10. A method according to claim 1, characterized by determining, in dependence on the respective second balance parameter value, a respective velocity profile for a respective of the one or more of the vehicles for at least a portion of the respective remainder of the respective route, and controlling the respective of the one or more of the vehicles according to the respective determined velocity profile.

11. A method according to claim 10, characterized by obtaining a respective vehicle model in the form of a mathematical model for the respective of the one or more of the vehicles, wherein the respective velocity profile is determined by means of the respective vehicle model.

12. A method according to claim 10, characterized by obtaining data for the respective route, wherein the respective velocity profile is determined in dependence on the route data.

13. A method according to claim 1, characterized in that the missions that the vehicles perform form a present set of missions, the method comprising performing a previous set of missions, wherein the respective second balance parameter value is determined in dependence on the previous set of missions.

14. A method according to claim 13, characterized by determining, for the previous set of missions, a value of a reward parameter, in dependence of a deviation of an actual time to complete all missions in the previous set of missions, from a desired time to complete all missions in the previous set of missions, wherein the respective second balance parameter value is determined in dependence on the reward parameter value.

15. A method according to claim 14, characterized in that the respective second balance parameter value is determined in dependence on a cost for operating the vehicles at the previous set of missions.

16. A method according to claim 1, characterized in that the respective second balance parameter value is determined by a control unit located remotely from the vehicles.

17. A computer program comprising program code means for performing the steps of claim 1 when said program is run on a computer, or a group of computers.

18. A non-transitory computer readable medium carrying a computer program comprising program code for performing the steps of claim 1 when said program code is run on a computer, or a group of computers.

19. A control unit, or a group of control units, configured to perform the steps of the method according to claim 1.
